(19) United States
(12) Patent Application Publication
(10) Pub. No.: US 2007/0226480 A1
(43) Pub. Date: Sep. 27, 2007

(54) Method for providing multi-user environment which varies source supply path of operating system, and computer system of the same

(76) Inventor: Ye Jin Kim, Seoul (KR)

Correspondence Address: GREENLEE WINNER AND SULLIVAN P C, 4875 PEARL EAST CIRCLE, SUITE 200, BOULDER, CO, 80301, US

(21) Appl. No.: 11/465,394

(22) Filed: Aug. 17, 2006

(30) Foreign Application Priority Data
Mar. 8, 2006 (KR) 10-2006-0021566

(51) Int. Cl. G06F 9/00

(52) U.S. Cl. 713/2

(57) ABSTRACT

A multi-user environment is provided, which varies a source supply path of an operating system, and a computer system of the same in which one user connects one external storing medium to a computer system using an external storing medium (for example, disk drive) so as to overcome the problems occurring in a conventional software work environment division method and sets a user environment using a storing medium connected by the user without using an operating system of a system when a computer system is booted.

### CROSS REFERENCE WITH RELATED APPLICATIONS

This application claims benefit of Korean Patent Application No. 10-2006-0021566, filed on Mar. 8, 2006, which is incorporated herein by reference in its entirety.

### BACKGROUND OF THE INVENTION

The present invention relates to a method for providing an environment matching with each user setting when a plurality of users use one computer system, and in particular to a method for providing a multi-user environment which varies a source supply path of an operating system, and a computer system of the same in which one user connects one external storing medium to a computer system using an external storing medium (for example, disk drive) so as to overcome the problems occurring in a conventional software work environment division method and sets a user environment using a storing medium connected by the user without using an operating system of a system when a computer system is booted.

Generally, a personal computer (PC) is designed to operate only based on an operating system (software which sets a certain environment for using other software in a PC) when a certain work is performed. When we turn on a computer, it is checked whether all elements properly work or not based on a series operation of complicated sets. When there is an error, the error is reported to the user. This booting operation is called a boot up or booting. It is performed for fully maintaining all elements so as to load an operating system.

Here, a conventional computer system comprises hardware such as a CPU, a memory device, etc, an application program such as a complier, a database system, a video game and a business program, a person user or users of other computers, and an operating system.

The operating system is a program which works an interface between the computer user and the computer hardware for thereby achieving a convenient and efficient use of the computer. Various input and output devices and user program are controlled, and a computer error is prevented, and the execution of the user program is controlled so as to prevent an illegal use of the computer.

As an operating system of the personal computer, there are various operating systems such as an old MS-DOS and a current windows environment. The above operating system is too large in its size. So, it is needed to load a single operating system using a file based on an input and output driver with respect to a program code and a certain interface routine.

The current personal computer system is advanced to a conventional workstation class computer in its performance based on an improved operating system and hardware. With the above high performance, a multi-user environment is developed, in which multiple users can use one computer.

Namely, in the case that multiple users use one computer at different time, each user sets his work environment. For example, assuming that a user A uses a CAD work environment, a user B uses a Korean word work environment, a user C uses an English word work environment, and a user D uses a Japanese word work environment, a user log-in procedure is performed at an initial booting operation of a computer system, so that each user can be provided with a certain computer system environment matching with his work environment.

So, when each user, for example, the user D logs in based on his set work environment, the Japanese windows operates, and the user D works a word work on the Japanese windows set by himself. There are not problems for using one resource by multiple users. It is possible to obtain an effect that each user can use his computer system.

In addition, when a common person, who does not have a high level knowledge on computer, uses a personal computer, a user account is set at a control panel, so that multiple users set their own windows environments. In this case, it is common that each user differently logs in on the same operation systems.

However, in the above-described case, only different windows and work environments are provided based on a software setting environment. As a result, since the same resource is shared, a critical error may occur during the work of a certain user. When a virus is infected or other user's data are damaged by mistake, the other user may lose his work environment.

### SUMMARY OF THE INVENTION

Accordingly, it is an object of the present invention to overcome the above-described conventional problems.

It is another object of the present invention to provide a method for providing an environment matching with each user setting when a plurality of users use one computer system.

It is further object of the present invention to provide a multi-user environment which varies a source supply path of an operating system, and a computer system of the same in which one user connects one external storing medium to a computer system using an external storing medium (for example, disk drive) so as to overcome the problems occurring in a conventional software work environment division method and sets a user environment using a storing medium connected by the user without using an operating system of a system when a computer system is booted.

To achieve the above objects, in a method for providing a multi-user environment using one computer system, there is provided a method for providing a multi-user environment which varies a source supply path of an operating system which comprises a first step in which it is judged that whether a certain storing medium is connected or not through a peripheral unit connection means; a second step in which it is judged whether a booting operation is performed or not through an external storing medium when in the first step, the connection is judged; and a third step in which when it is judged that the booting is performed through the external storing medium in the second step, the booting possible path of the internal storing medium is closed, and the booting is performed based on the operating system in a corresponding external storing medium.

Judging whether the booting is performed based on the external storing medium in the second step is determined based on the selection switch state of the user.

Judging whether the booting is performed based on the external storing medium in the second step is determined based on the priority which is given when the operating system exists in the external storing medium connected through the peripheral unit connection means.

The switch method of the supply path of the operating system in the third step is performed based on the power supply path change or the control signal transfer path change.

To achieve the above objects, in a computer system which comprises a CPU, a main memory (RAM), a BIOS ROM, an internal hard disk, a display unit and a keyboard, there is provided a multi-user environment provision computer system which varies a source supply path of an operating system which comprises a peripheral unit connection part which performs an interface with an external unit; an external hard disk which is connected with the peripheral unit connection part; a peripheral unit engaging recognition part which recognizes the kinds and spec of the peripheral units connected with the peripheral connection unit; and a power switch unit which selectively supplies a primary power from the power unit to the internal hard disk or the external hard disk in accordance with a control signal of the CPU.

### DESCRIPTION OF THE DRAWINGS

The present invention will become better understood with reference to the accompanying drawings which are given only by way of illustration and thus are not limitative of the present invention, wherein;

FIG. 1 is a view illustrating a computer system of a multi-user environment which varies a source supply path of an operating system according to the present invention.

### DETAILED DESCRIPTION OF THE INVENTION

The preferred embodiments of the present invention will be described with reference to the accompanying drawings.

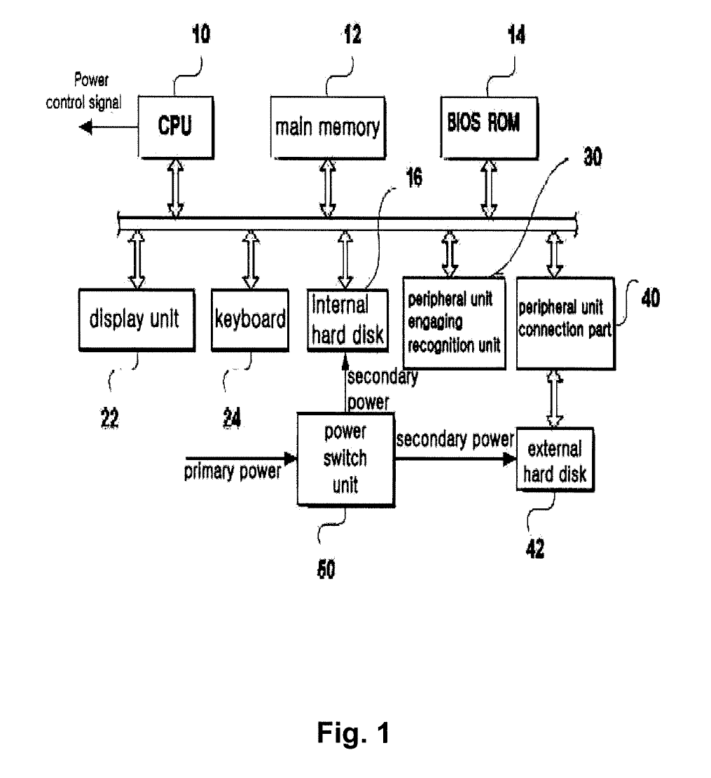

FIG. 1 is a view illustrating a computer system of a multi-user environment which varies a source supply path of an operating system according to the present invention. The computer system comprises a basic construction which includes a CPU 100, a main memory (RAM 12), a BIOS ROM 14, an internal hard disk 16, a display unit 22, and a keyboard 24. In addition to the above basic construction, there are further provided a peripheral unit connection part 40, an external hard disk 42 connected to the peripheral unit connection part 40, a peripheral unit engaging recognition part 30 which recognizes kinds and specification of a peripheral unit connected to the peripheral unit connection part 40, and a power switch unit 50 which selectively supplies a primary power from a power unit (not shown) to the internal hard disk 16 or the external hard disk 42 in accordance with a control signal of the CPU 10.

The above constructions are connected through buses.

The operation of the computer system of the multi-user environment, which varies the source supply path of the operating system according to the present invention, will be described.

The CPU 10 performs various works based on the program stored in the main memory 12 and the BIOS ROM 14.

The main memory 12 is designed to store many programs which will be performed by the CPU 10. The BIOS ROM 14 stores a basic data for process in the CPU 10 and a boot program including a minimum content needed for booting the computer system.

Here, the internal hard disk 16 is provided with an inherent operating system of the computer system and provides a certain user for the use of the computer system or a standard work environment.

The varying operation of the source supply path of the operating system according to the present invention will be described. A certain user connects the external hard disk 42, which stores a booting system, an operating system and his work environment, to the peripheral unit connection part 40 and turns on the computer power.

Here, the CPU 10 of the computer system operates in the system operation standby mode based on the data stored in the BIOS ROM 14 and checks whether there is a peripheral unit connected with the current peripheral unit connection part 40 through the peripheral unit engaging recognition part 30. The peripheral engaging recognition part 30 confirms whether the peripheral part connected with the peripheral engaging connection part 40 is the external hard disk 42 or not.

At this time, when the peripheral unit connected with the peripheral unit connection part 40 is the external hard disk 42, the peripheral unit engaging recognition part 30 provides the CPU 10 with an information (for example, acquisition information for hard disk recognition such as the number of clusters), and the CPU 10 changes the booting related information stored in the BIOS ROM 14 and outputs a control signal so that the operating system is booted through the external hard disk 42, not by the operating system through the internal hard disk 16.

The control signal of the CPU 10 is outputted to the power switch part 50, and the power switch unit 50 selectively supplies a primary power from the power unit (not shown) to the internal hard disk 16 or the external hard disk 42 in accordance with a control signal. The secondary power supplied to the internal hard disk 16 is supplied only to the external hard disk 42 in accordance with a control of the CPU 10.

Since the internal hard disk 15 does not work, the hard disk of a corresponding computer system operates like the external hard disk 42. The user of the external hard disk uses the computer based on the operating system and work environment supplied from the external hard disk.

Assuming that the Korean windows environment is set in the internal hard disk 16, and the Japanese windows environment is set in the external hard disk 42, in the case that the basic user uses the computer, since the external hard disk 42 is not connected with the peripheral unit connection part 40, the booting operation is performed based on the operating systems of the internal hard disk 16. It operates identically with the conventional computer system operation method, so that the Korean windows environment is provided.

In the case that when another user connects the external hard disk having the Japanese windows environment to the peripheral unit connection part 40, the system provides the external hard disk 42 with a priority, so that the internal hard disk 16 does not work, and the external hard disk 42 operates, whereby the Japanese computer system has the Japanese windows environment.

In the above case, the priority based on the booting of the operating system is automatically provided to the external hard disk rather than the internal hard disk. According to the implementation, the user can allow the manual switch to primarily select the internal hard disk or the external hard disk before the power turn-on by the user by manually performing the power switch unit 50.

In addition, the embodiments of FIG. 1 may be implemented based on the method of the power supply control or the switch of a control signal line. The above embodiment is also included in the scope of the present invention.

As described above, according to the present invention, there are provided a method for providing a multi-user environment which varies a source supply path of the operating system and a computer system. In the present invention, the source of the hard disk is not shared by multiple users, and the source of the common computer system excluding the hard disk is shared. Each user has the hard disk unit which supports the work environment and the operating system. So, his inherent work environment is maintained, and it is possible to prevent the data done by himself from being exposed to other users.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a method for providing a multi-user environment using one computer system, a method for providing a multi-user environment which varies a source supply path of an operating system, comprising:
a first step in which it is judged that whether a certain storing medium is connected or not through a peripheral unit connection means;
a second step in which it is judged whether a booting operation is performed or not through an external storing medium when in the first step, the connection is judged; and
a third step in which when it is judged that the booting is performed through the external storing medium in the second step, the booting possible path of the internal storing medium is closed, and the booting is performed based on the operating system in a corresponding external storing medium.

2. The method of claim 1, wherein judging whether the booting is performed based on the external storing medium in the second step is determined based on the selection switch state of the user.

3. The method of claim 1, wherein judging whether the booting is performed based on the external storing medium in the second step is determined based on the priority which is given when the operating system exists in the external storing medium connected through the peripheral unit connection means.

4. The method of claim 1, wherein said switch method of the supply path of the operating system in the third step is performed based on the power supply path change or the control signal transfer path change.

5. In a computer system which comprises a CPU, a main memory (RAM), a BIOS ROM, an internal hard disk, a display unit and a keyboard, a multi-user environment provision computer system which varies a source supply path of an operating system, comprising:
a peripheral unit connection part which performs an interface with an external unit;
an external hard disk which is connected with the peripheral unit connection part;
a peripheral unit engaging recognition part which recognizes the kinds and spec of the peripheral units connected with the peripheral connection unit; and
a power switch unit which selectively supplies a primary power from the power unit to the internal hard disk or the external hard disk in accordance with a control signal of the CPU.
